(19) United States
(12) Patent Application Publication
(10) Pub. No.: US 2022/0203849 A1
(43) Pub. Date: Jun. 30, 2022

(54) WIRELESS POWER TRANSFER SYSTEMS

(71) Applicant: INTDEVICE LIMITED, East Tamaki, Auckland (NZ)

(72) Inventor: Li Jun YU, Mellons Bay, Auckland (NZ)

(73) Assignee: INTDEVICE LIMITED, East Tamaki, Auckland (NZ)

(21) Appl. No.: 17/600,293

(22) PCT Filed: Apr. 2, 2020
(86) PCT No.: PCT/IB2020/053121

§ 371 Date: Sep. 30, 2021

(30) Foreign Application Priority Data
Apr. 5, 2019 (NZ) 752411

(51) Int. Cl. B60L 53/124; H02J 50/40; H02J 50/10; B60L 53/38; H02J 50/60; H02J 50/90

(52) U.S. Cl. CPC B60L 53/124; H02J 50/402; H02J 50/90; B60L 53/38; H02J 50/60; H02J 50/10

(57) ABSTRACT

A charging unit for wireless power transfer. The charging unit includes at least one coil for inductive power transfer, a sensor coil array with a sensing field for sensing the presence of at least one foreign object, and a controller. The controller is configured to move the sensor coil array and/or sensing field so that the sensing field can scan a sensing region, and configured to detect the presence of the at least one foreign object in the sensing region based on the sensing array output. The sensor coil array and/or sensing field is moveable such that the sensing field can be:
a) positioned in the sensing region so that the sensing field does not overlap the at least one foreign object, and also b) positioned in the sensing region so that the sensing field does overlap the at least one foreign object.

### FIELD OF THE INVENTION

The present invention relates to wireless power transfer systems (either charging or real-time power systems) and apparatus for detecting foreign objects thereon.

### BACKGROUND TO THE INVENTION

FIG. 1 illustrates a prior art wireless power transfer charging system 10 for charging an electric vehicle 11. The charging system comprises a central charging unit 12 with a power supply 9 and controller 8 for controlling the supply of power to the electric vehicle 11, and also comprises a wireless charging unit 13 that inductively transfers power 15 to the electric vehicle 11. The central charging unit 12 is electrically coupled 16 to the wireless charging unit 13. The wireless charging unit 13 can take the form of a wireless charging pad 40 comprising one or more inductive coils 14 for transferring power across to the electric vehicle 11.

In operation, the central charging unit 12 induces an alternating current into the inductive coils 14, which generates a changing electromagnetic field/flux in and around the inductive coils 14. The electric vehicle has a receiver 17 that receives power inductively transferred from the wireless charging unit 13. The receiver 17 is electrically coupled to a rechargeable battery 18. If the receiver 17 of the electric vehicle 11 is in the vicinity of the wireless charging pad 13, the changing electromagnetic field/flux induces an alternating current in the inductive coils of the receiver 17, thereby creating a wireless transfer of power 15 to the electric vehicle 11.

If a foreign object is also located in the vicinity of the wireless charging pad 13, then the changing electromagnetic field will induce eddy currents within the foreign object. If the electrical resistance of the foreign object is low, then the foreign object will start to heat, and continuous exposure to the electromagnetic flux increases the risk of the foreign object becoming a heating and/or fire hazard.

### SUMMARY OF THE INVENTION

It is an object of the present invention to provide for sensing of objects in wireless power transfer.

The present embodiments provide a foreign object detection system for a wireless power transfer charging system 10, so that if a foreign object is on or close enough to the wireless charging pad 13, then remedial action can be taken. For example, the wireless charging pad 13 can power down and/or switch off to prevent the foreign object from becoming a safety hazard.

In one aspect, the present invention may be said to comprise a charging unit for wireless power transfer, comprising: at least one coil for inductive power transfer, a sensor coil array with a sensing field for sensing the presence of at least one foreign object, and a controller configured to: move the sensor coil array and/or sensing field so that the sensing field can scan a sensing region, and detect the presence of the at least one foreign object in the sensing region based on the sensing array output, wherein the sensor coil array and/or sensing field is moveable such that the sensing field can be: a) positioned in the sensing region so that the sensing field does not overlap the at least one foreign object, and also b) positioned in the sensing region so that the sensing field does overlap the at least one foreign object.

Optionally, the charging unit is for wirelessly charging an electric vehicle through inductive power transfer.

Optionally, the charging unit further comprises an arm, wherein the sensor coil array is disposed on the arm, and the controller can control the move the arm to position the sensing field in the sensing region.

Optionally, the arm as a rotatable arm and the controller can rotate the arm to position the sensing field.

Optionally, the arm is a slidable arm and the controller can slide the arm to position the sensing field.

Optionally, the charging unit has an operational region and the sensing region overlaps the operational region.

Optionally, the sensor coil array and/or sensing field are smaller than the operational region.

Optionally, the charging unit further comprises one or more additional sensor arrays for sensing the presence the at least one foreign object.

Optionally, each additional sensor array is disposed on a respective additional arm.

Optionally, the charging unit comprises electromagnetic shielding material for shielding the sensor coil array from electromagnetic interference.

Optionally, the charging unit is for wirelessly charging one or more of the following:
electrical system
battery
scooter
e-bike
robot
other electronic device

In another aspect, the present invention may be said to comprise a charging unit for wirelessly charging an electric vehicle through inductive power transfer, comprising: at least one coil for inductive power transfer, a sensor coil array with a sensing field for sensing the presence of a foreign object, and a controller configured to: move the sensor coil array and/or sensing field so that the sensing field can scan a sensing region, and detect the presence of a foreign object in the sensing region based on the sensing array output, wherein the sensor coil array and/or sensing field is moveable such that the sensing field can be: a) positioned in the sensing region so that the sensing field does not overlap the foreign object, and also b) positioned in the sensing region so that the sensing field does overlap the foreign object.

In another aspect, the present invention may be said to comprise a sensing unit for a charging unit for wireless power transfer comprising: a sensor coil array with a sensing field for sensing the presence of at least one foreign object, and a controller or in communication with a controller configured to: move the sensor coil array and/or sensing field so that the sensing field can scan a sensing region, and detect the presence of the at least one foreign object in the sensing region based on the sensing array output, wherein the sensor coil array and/or sensing field is moveable such that the sensing field can be:

a) positioned in the sensing region so that the sensing field does not overlap the at least one foreign object, and also positioned in the sensing region so that the sensing field does overlap the at least one foreign object.

Optionally, the charging unit is for wirelessly charging an electric vehicle through inductive power transfer.

Optionally, the charging unit further comprises one or more sensor arrays for sensing the presence the at least one foreign object.

Optionally, the charging unit is for wirelessly charging one or more of the following:
electrical system
battery
scooter
e-bike
robot
other electronic device

In another aspect, the present invention may be said to comprise a wireless power transfer system comprising a charging unit and/or a sensing unit according to any one of the preceding aspects of the present invention.

In another aspect, the present invention may be said to comprise a power system for wireless power transfer for charging and/or real-time powering of a system or device, comprising: at least one coil for inductive power transfer, a sensor coil array with a sensing field for sensing the presence of at least one foreign object, and a controller configured to: move the sensor coil array and/or sensing field so that the sensing field can scan a sensing region, and detect the presence of the at least one foreign object in the sensing region based on the sensing array output, wherein the sensor coil array and/or sensing field is moveable such that the sensing field can be: a) positioned in the sensing region so that the sensing field does not overlap the at least one foreign object, and also b) positioned in the sensing region so that the sensing field does overlap the at least one foreign object.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE FIGURES

Preferred embodiments of the invention will be described by way of example only and with reference to the drawings, in which:

FIG. 1 is an overview of a prior art wireless power transfer charging system.

FIG. 2 is a general overview of a wireless power transfer charging system according to the described embodiments.

FIG. 3 is a block diagram overview of the wireless charging unit according to the described embodiments.

FIG. 4 is a block diagram overview of the sensing unit according to the described embodiments.

FIG. 5 is a plan view of one embodiment of the sensing unit.

FIG. 6 is a line diagram showing an example of how one embodiment of the sensing unit senses and detects a foreign object.

FIG. 7 is a plan view of another embodiment of the sensing unit.

FIG. 8 is a line diagram showing an example of how another embodiment of the sensing unit senses and detects a foreign object.

FIG. 9 is a plan view of another embodiment of the sensing unit.

FIG. 10 is a plan view of another embodiment of the sensing unit.

FIG. 11 is a plan view of a prior art foreign object detection system.

FIG. 12 is a line diagram demonstrating why it can be difficult to detect a foreign object using a prior art foreign object detection system.

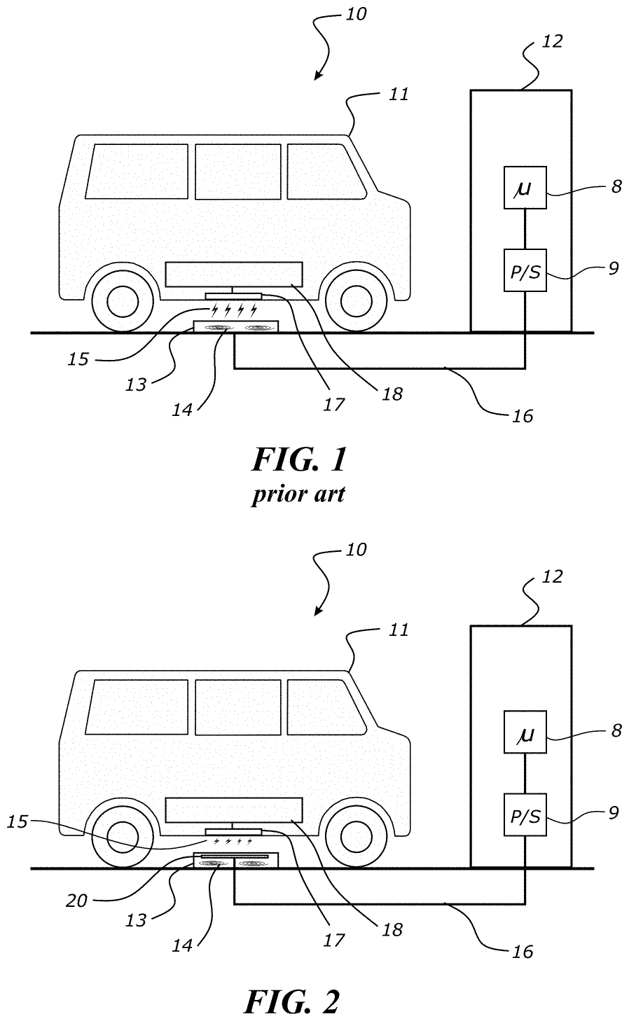

### DETAILED DESCRIPTION

Overview of Embodiments Described

FIG. 2 shows a wireless power transfer charging system 10 for charging an electric vehicle 11 configured to enable detection of foreign objects in an operational area of wireless charging unit 13.

The wireless power transfer charging system 10 comprises a central charging unit 12 for controlling the supply of power to the electric vehicle 11, and also comprises a wireless charging unit 13 that inductively transfers power 15 to the electric vehicle 11. The electric charging unit 13 is electrically coupled 16 to the central charging unit 12. The wireless charging unit 13 can take the form of a wireless charging pad comprising one or more inductive coils 14 for transferring power 15 across to the electric vehicle 17, 18.

In operation, the central charging unit 12 induces an alternating current into the inductive coils 14, which generates a changing electromagnetic field/flux in and around the inductive coils 14. The electric vehicle 11 has a receiver 17 that receives power inductively transferred 15 from the wireless charging unit 13. The receiver 17 is electrically coupled to a rechargeable battery 18. If the receiver 17 of the electric vehicle 11 is in the vicinity of the wireless charging pad 13, the changing electromagnetic field/flux induces an alternating current in the inductive coils of the receiver 17, thereby creating a wireless transfer of power 15 to the electric vehicle 13. A foreign object sensing unit 20 is provided to detect any foreign objects in an operational area of the charging unit 13.

In general terms, the embodiments described provide a sensing unit 20, wireless power transfer charging unit 13 with a sensing unit 20 and/or a wireless power transfer charging system 10 with a charging unit 13, whereby the sensing unit 20 can sense and detect foreign objects (on or near the charging unit) that might present a hazard as previously set out.

Embodiments disclosed herein are described in terms of sensing and detecting a singular foreign object as opposed to two or more foreign objects. This is for the purpose of providing a simplified explanation as to how foreign objects may be sensed and detected by the embodiments described herein. Those skilled in the art would understand that the described embodiments are capable of sensing and detecting a single foreign object, and are also capable of sensing and detecting two or more foreign objects. This is because the techniques used to sense and detect a single foreign object can also be used to detect two or more foreign objects.

Embodiments of the wireless power transfer charging system 10, sensing unit 20, and wireless power charging unit 13 described herein are all described in the context of wirelessly charging an electric vehicle 11. However, a skilled person would appreciate that the described embodiments may also be suitable for systems that power an electrical system in real time or suitable for charging a battery. Further, the described embodiments may be suitable for charging scooters, e-bikes, robots, and other similar electronic devices.

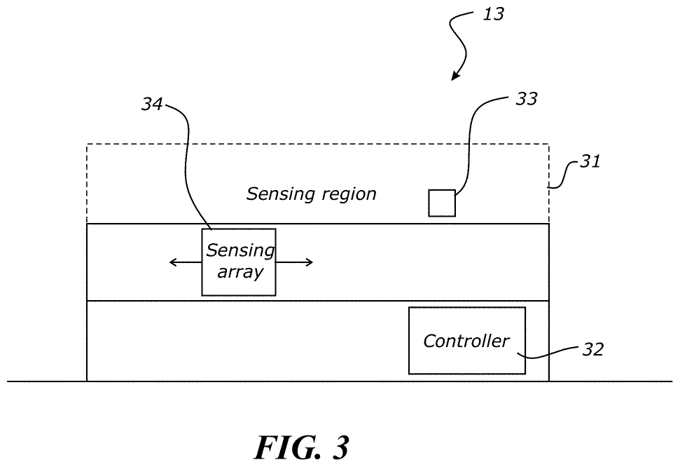

Various embodiments of a wireless charging unit 13 that can sense foreign objects are described. In overview, referring to the diagrammatic FIG. 3, the embodiments provide a sensing coil array 34 that can scan a sensing region 31 and a controller 32 that can detect a foreign object 33 in the sensing region 31. Upon detection, suitable action can be taken to prevent the hazard, such as shutting off the wireless charging unit 13. Typically, the sensing coil array will be in the housing of the charging unit 13.

The controller 32 can be used to detect a foreign object 33. In addition, the controller 32 can be used to operate any actuators for moving sensing array 34, and the controller 32 can be used to power the sensing coil array 34 (including the sensing coils themselves). The controller 32 can refer to one or more controllers that can be placed anywhere in wireless charging unit 13.

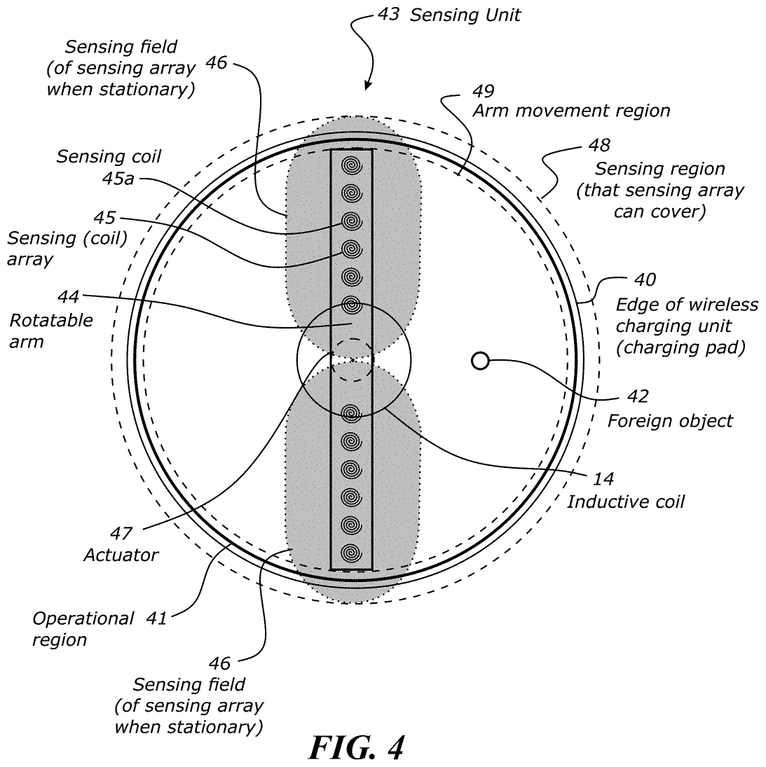

Referring to FIG. 4, various general features of the wireless charging unit 13 and sensing unit 20 are shown in general diagrammatic form. The various geometric regions are shown for illustrative purposes only, and may not correspond to actual geometric regions of a charging unit according to the embodiments described.

The charging unit 13 takes the form of a charging pad 40 with a housing covering a region. In this case the pad 40 and housing is round, but they could take other shapes, such as square, rectangular or other shape. The charging pad 40 comprises wireless power transfer charging coils (“power coils”) 14—in this case one, although the actual number will depend on the charging unit 13. The coil 14 has an operational region 41, being the region over which the electromagnetic field of the power coils 14 can operate to provide power transfer 15 to an electric vehicle 11. Foreign objects 42 falling within the operational region 41 are at risk of creating an overheating hazard, as they receive the power intended for the vehicle 11. Therefore, the embodiments herein are intended to detect such foreign objects 42 within the operational region 41. The geometry of the operational region 41 may or may not coincide exactly with the geometry of the charging pad region 40. The operational area 41 may coincide with the charging pad area 40, partially coincide, be bigger or be smaller, depending on the range of the wireless power transfer 15. Typically, the operation region 41 and charging pad region 40 would be closely aligned. Reference to the term “overlap” in relation to the operational region 41 and the charging pad 40 will mean that the operational region 41 at least partially coincides (irrespective of whether it is bigger or smaller) with the charging pad 40, and may fully coincide (that is, the same size and substantially fully aligned) with the charging pad 40, or it may even be bigger than the charging pad 40. Reference to the term “covers” means that the region at least aligns with or is even bigger than the other region.

The charging unit 13 has sensing unit (generally depicted as 43). The sensing unit 43 might be integrated with the charging unit 13, or a separate apparatus, and may be retrofittable or incorporated at the time of manufacture. The sensing unit 43 comprises a sensor arm 44, and a sensor coil array 45 disposed on the sensor arm 44. The sensor coil array 45 is shown as a single array of a plurality of sensing coils e.g. 45a, but this is exemplary only and other geometries and numbers of sensing coils are possible. The sensor coil array 45 has an electromagnetic sensing field (“sensing field”) 46, which is the geometric region over which the sensor coil array 45 can operate/sense foreign objects 42 to a suitable level of measurement.

The sensor coil array 45 (and thus the sensing field 46) is smaller than the operational region 41, for advantageous reasons that will be explained later. As a result, the sensing field 46 does not cover/overlap and cannot sense foreign objects 42 over the entire operational region (when stationary). Therefore, the sensing unit 46 has a controller 32 and an actuator 47 that under control of a controller 32 can operate the sensor coil array 45 so that the sensing field 46 can scan a larger area. This might be by way of moving the sensor arm 44 and/or sensor coil array 45 so that the sensing field 46 scans a larger area. The area that the sensing field 46 scans is the sensing region 48. The sensing region 48 is the region over which the foreign object sensing unit 20 can sense and detect a foreign object 42. Preferably, the sensing region 48 is at least the same size of, and fully covers, the operational region 41 of the charging unit 13. The sensing region area 48 might be bigger than the operational region area 41. However, it might not be absolutely essential that the sensing region 48 is the same size or bigger than the operational region 41, and a sensing region 48 that covers only part of the operational region 41 might still be useful. Some benefits can still be gained even if the sensing area 48 doesn't coincide completely with the operational area 41, for example it overlaps but does not completely cover it. However, any operational region 41 not scanned is at risk of harbouring foreign objects 42 that won't be detected and may pose a heating hazard. Reference to the term “overlap” in relation to the operational region 41 and the sensing region 48 will mean that the sensing region 48 at least partially coincides (irrespective of whether it is bigger or smaller) with the operational region 41, and may fully coincide (that is, the same size and substantially fully aligned) with the operational region 41, or it may even be bigger than the operational region 41. Reference to the term “covers” means that the region at least aligns with or is even bigger than the other region. As shown, in FIG. 4, the sensing region 48 is slightly bigger than the operation region 41.

The sensing field 46 may not coincide with the geometry of the sensor arm 44. Typically, it might be bigger than the sensor arm 44, although that is not essential and it might have other relationships to the sensor arm 44 such as coinciding with the sensor arm 44, partially or fully overlapping the sensor arm 44 and/or being smaller than the sensor arm 44.

As shown in FIG. 4, the arm 44 can be moved by an actuator 47 so that the sensing coil array 45 rotates to scan (sweep out) the sensing region 48. In this case, the arm 44 is rotated to sweep out a circular sensing region 48. It can be seen that the actual area that the arm 44 sweeps (arm movement region 49) is less than the sensing region 48, because the sensing field 46 is slightly longer than the arm 44 so it sweeps a larger radius. Having a rotating sensor arm 44 is only one option for moving the sensing field 46, and other options are possible creating a different shape sensing region 48—some of which will be described below.

The sensing field 46 and sensing region 48 geometry are arranged in relation to the operational region 41 so that there is at least one position of the sensing field 46 such that the sensing field 46 does not overlap (that means it does not partially or fully coincides with) a foreign object 42 in the operational area 41, and at least one position of the sensing field such that it does overlap (that means at least partially or fully coincides with) a foreign object 42 in the operational area 41. In practice, there will usually be multiple positions of both, but as long as there is at least one position for each, the sensing field 46, sensing region 48 could and movement could take various different geometries and motions.

Shielding is helpful for attenuating the electromagnetic field emitted from the power coils 14, such that electromagnetic interference with the signals induced in the sensing coils 45a of the sensing array 45 is mitigated. The arm of this embodiment can incorporate more shielding material, because the sensing bar 44 occupies a smaller area relative to the sensing region 48.

It should be appreciated that the boundaries of the regions shown in FIG. 4 that relate to electromagnetic fields may not be the actual shape of those regions. The shapes have been shown for exemplary purposes only. It should also be appreciated that the boundaries of the regions shown will not actually be “hard” boundaries—that is, the electromagnetic fields depicted will not necessarily become zero immediately outside the boundary. Rather, electromagnetic fields attenuate as a function of the distance from the source of the field. The boundaries of the regions depicted are indicative only, and show where it may be deemed that the effective field has ended. Those skilled in the art will appreciate this, and the boundaries should not be considered limiting in such a manner that they limit the scope of the invention in a manner that goes against the concepts described herein.

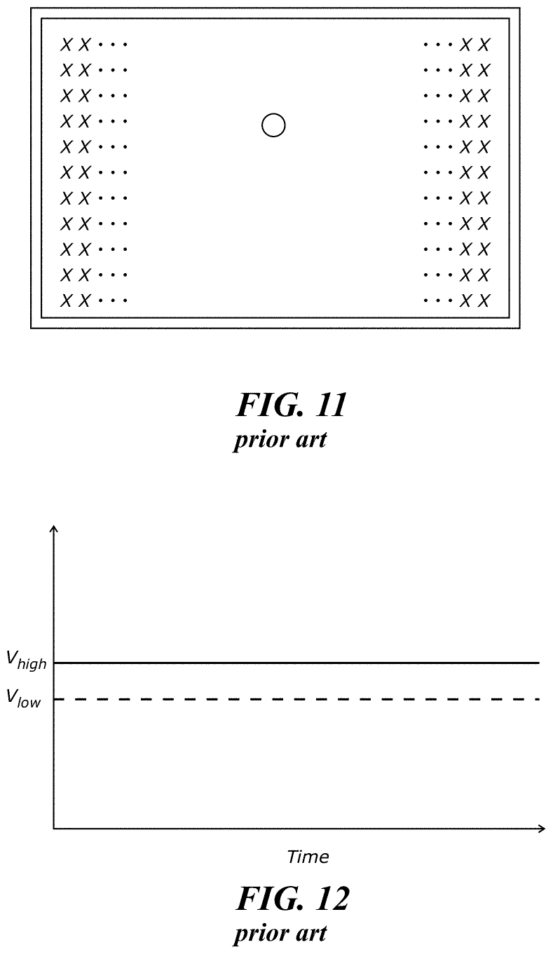

The embodiments described herein have advantages over prior art sensing arrays as follows.
The sensor coil array 45 does not need to be the same size as the operational area 41 to effectively detect foreign objects 42 in the operational region. Rather a smaller sensor coil array 45 can be used. A small footprint of sensor coil array 45 can be used. This saves on cost of coils, and the attendant control and sensing electronics.
The coils of a prior art sensing array preferably are shielded so that the field of the wireless power transfer coils 14 do not interfere with the sensing coils 45. But, if the prior art coil array is of a substantial size, then there is a large area of shielding, which will prevent or attenuate power being transferred to the vehicle 11. In contrast, the smaller sensor coil array 45 of the embodiments described herein require a smaller area of shielding, so they do not shield all or a substantial portion of the power coils 14, and so do not attenuate power transfer to as large a degree. As the sensor coil array 45 requires a smaller area of shielding, a greater level (e.g. thickness) of shielding around the sensor coil array 45 can be provided without impeding on the operation of the wireless power transfer coils 14. The extra shielding reduces electromagnetic interference from the wireless power transfer coils 14, which improves the quality of the signal sensed by the sensor coil array 45. This improves the accuracy and/or precision of the sensor coil array 15 measurements. Further, the extra shielding thickness allows the controller 32 to be placed closer to the sensor coil array 45. Placing the controller 32 physically closer to the sensor coil array 45 also improves the accuracy and/or precision of the sensor coil array 45 measurements.
When detecting foreign objects 42 using a sensor coil array, having a reference helps distinguish between whether a foreign object 42 is present or not. With a prior art sensor coil array 15 that covers a substantial portion or all of the operational region, as shown in FIG. 11 for example, it is likely that a foreign object 42 will always be sensed to some degree. It is therefore hard to determine the difference from when an object 42 is there, to when it isn't, see FIG. 12 for example. In contrast, the present embodiments have a situation where the size of the sensing field 46 is such that only it sometimes senses the object 42, and other times does not, so the two readings can distinguish between an object 42 being there or not.

Particular exemplary embodiments will now be described. These are not limiting, and are by way of example only. Various other embodiments could be envisaged by those skilled art that still meet the aspects of the invention.

Specific embodiments according to the present invention will now be discussed.

### 1. First Embodiment

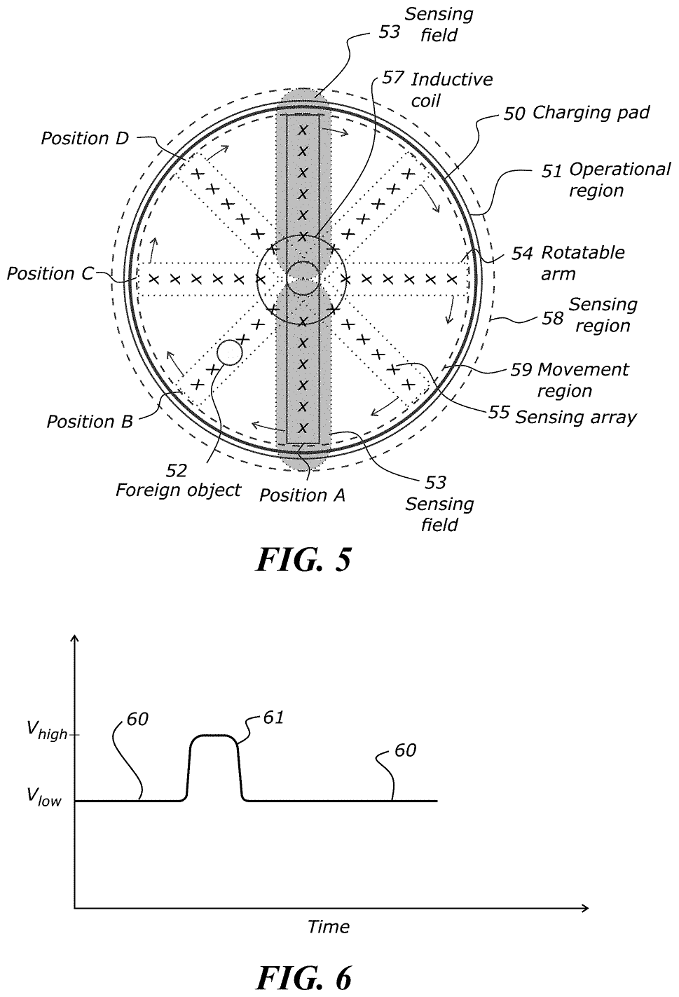

A first embodiment will now be discussed with reference to FIGS. 5 and 6.

The charging unit 13 forming part of the system of FIG. 2 could be as shown in FIGS. 5 and 6. The various features of this embodiment will be renumbered with respect to previous figures, but they still relate to the same aspects where context dictates. The charging unit 13 of this embodiment comprises a circular pad 50 comprising a housing and at least one wireless power transfer coil 57. The charging unit 13 has a rotatable sensor arm (“rotatable arm”) 54 disposed above the pad 50 on a rotatable actuator, such as an electric motor. Preferably, the rotatable arm is in the charging unit housing, although this is not essential. The rotatable actuator is controlled to rotate by way of a controller (e.g. 32 in FIG. 3), disposed in the charging unit 13 or disposed elsewhere in the system. An array of sensor coils 55 is disposed on the rotatable arm 54. The arm is sized appropriately to carry the sensor coil array 55. The sensor coils 55 can be any suitable used in the art. The rotatable arm 54 and/or sensor coils 55 can be shielded to reduce interference from the charging coil 14.

The following regions are also shown:
A charging pad housing 50 that is circular.
A circular operational region 51, being the region over which the wireless power transfer coil 14 can transfer power. This typically would be of similar region to the charging pad 50, that is that they overlap.
A rotatable arm 54 with sensor coils 55 that covers an elongated rectangular region.
A sensing field 53, which is the region that the sensor coils 55 can sense an object 52 when the rotatable arm 54/sensor coil array 55 is in a particular position.
A circular sensing region 58, being the region over which the sensing field 53 scans or sweeps through rotatable movement of the arm 54.

The area covered by the sensor coil array 55 and the rotatable arm 54 and sensing field 53 is a small proportion of the overall operational area 51, which is advantageous for the reasons described above. In particular, the sensing field 53 and sensing region geometry 58 are arranged in relation to the operational region 51 so that there is at least one position of the sensing field 53 such that it does not overlap the foreign object 52 in the operational area (see e.g. position A, position C and position D), and at least one position of the sensing field 53 such that it does overlap the foreign object 52 in the operational area (see position B). In practice, there will be many such positions of each. There is vertical clearance between the rotatable arm 54 and the charging unit pad 50 so that as the arm 54 rotates it will pass above any foreign object 52 on the pad 50 or otherwise in the operational area 51.

In use, the rotatable arm 54 is rotated by the actuator under control of the controller 32 so that the sensor coil array 55 scans/sweeps out the circular arm movement region 59 and the sensing field 53 scans/sweeps out a sensing region 58, allowing the sensor coil array 55 to sense any foreign object 52 located in the sensing region 58/operational region 51. Four positions of the rotatable arm 54 are shown (positions A, B, C and D), although it will be appreciated that the arm 54 will rotate through a continuous range of different positions. As can be seen, as the arm 54 rotates, for most of the positions, the sensing field 53 does not cover the foreign object 52, but for a small part of the scan (for a smaller range of positions) the arm 54 covers (and therefore the sensing field 53 covers) the foreign object 52.

The sensor coil array 55 will not sense the object 52 when the rotating arm 54/sensor coil array 55 is positioned so the sensing field 53 does not overlap (such as not cover or is too far away to sense) any of the foreign object 52. See for example positions A and C. The controller 32 receives output from the sensor coil array that is essentially a null signal 60 (see FIG. 6) or a signal indicative of no object. Once the sensor coil array 55 is in one of the positions such that the sensing field 53 overlaps (such as covers or is near enough to sense) a foreign object 52 (e.g. position B), the controller 32 receives output from the sensor coil array 55 that is a positive signal 61a,b (see FIG. 6) from which the controller detects the foreign object 52. The controller 32 can use the relative outputs from when the sensing field 53 does not sense or overlap the object 52 to when it does overlap/sense the object 52 to assist in distinguishing the two events.

For example, at position A, the sensing bar 54 is oriented in a “north-south” direction, and the foreign objects 52 are not overlapped by (and is too far away from) the sensing field 53. The foreign object 52 is too far from the sensing field 53 to induce an electrical signal into any of the sensing coils 55 located along the arm 54. As no electrical signal is induced in any of the sensing coils 55, the controller 32 receives a (“low”) zero reading 60 from the sensor coil array 55. The rotatable arm 54 begins to rotate clockwise towards position B. At position B, the arm 54 is oriented in a “north east-south west” direction. At this position, the sensor coil array 55 overlaps the foreign object 52. Since an electrical signal is induced in at least one of the sensing coils 55, the controller 32 receives a (“high”) non-zero reading 61. The arm 54 continues to rotate clockwise towards position C. At position C, the sensor coil array 55 is oriented in a “west-east” direction. At this position, the foreign object 52 is too far from the sensor coil array 55 to induce an electrical signal into any of the sensing coils 55 located along the rotatable arm 54. As no electrical signal is induced in any of the sensing coils 55, the controller 32 receives a (“low”) zero reading 60 from the sensor coil array 55. The arm 54 continues to rotate clockwise towards position D. At position D, the sensing bar 54 is oriented in a “north west-south east” direction. At this position, the foreign object 52 is too far from the sensor coil array 55/sensing field 53 to induce an electrical signal into any of the sensing coils 55 located along the rotatable bar 54. As no electrical signal is induced in any of the sensing coils 55, the controller receives a (“low”) zero reading 60 from the sensor coil array. The arm 54 continues to rotate clockwise towards position A, and can continue to rotate clockwise.

By rotating the sensing bar 54 from position A to position D and position A again, the controller 32 receives a (“low”) zero reading 60 and a (“high”) non-zero reading 61. The controller is able reference the a (“high”) non-zero reading 61 against the (“low”) zero 60 reading to correctly determine that there is a foreign object 52 within the sensing region 58. The controller 32 then powers down the inductive coil 57 of the charging pad to prevent induction heating of the foreign object 52. The foreign object 52 is then no longer an induction heating hazard.

Once the detection takes place the controller 32 can communicate with the central charging unit 12 to take appropriate action, such as shutting down power transfer.

Those skilled in the art would understand that as alternative to continuously moving the bar 54 in a continuous clockwise direction, the bar 54 can rotate in other ways. For example, the rotatable bar 54 can move with an alternating “stop” and “start” movement. In another example, the rotatable bar 54 can rotate in an anti-clockwise direction. In another example, the rotatable bar 54 can alternate between moving in a clockwise direction and in an anti-clockwise direction.

The disclosed embodiment suggests sensing and detecting different voltage signals (i.e. a non-zero reading when a foreign object is present, and a zero reading when a foreign object is absent) to determine whether a foreign object 52 is present in the sensing region 53. Those skilled in the art would understand that the controller 32 can be configured to instead measure a different parameter to ascertain whether a foreign object 52 is present in the sensing region 53. That is, instead of using relative voltage levels, the controller can instead measure frequency, phase shift, or some other parameter, for example.

### 2. Second Embodiment

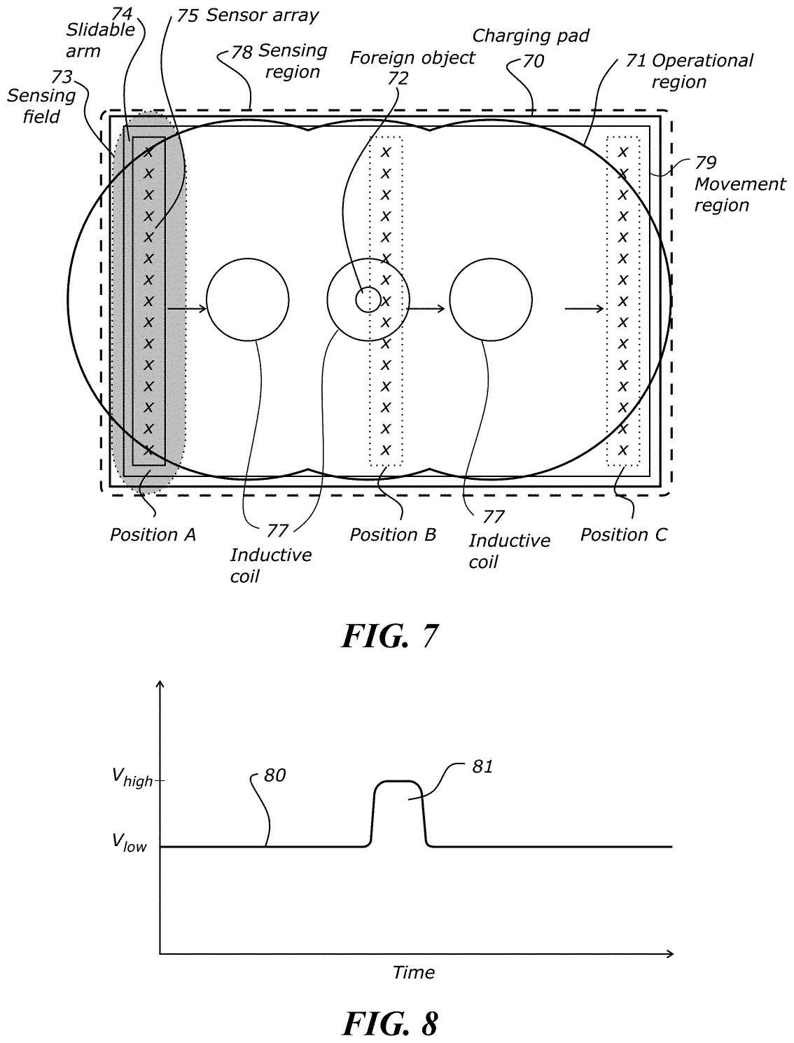

A second embodiment will now be discussed with reference to FIGS. 7 and 8.

The charging unit 13 forming part of the system of FIG. 2 could be as shown in FIGS. 7 and 8. The various features of this embodiment will be renumbered with respect to previous figures, but they still relate to the same aspects where context dictates. The charging unit 13 of this embodiment comprises a rectangular pad 70 comprising a housing and at least one power coil 77 (in this case three coils). The charging unit 13 has a slidable sensor arm (“slidable arm”) 74 disposed above the pad 70 on a sliding actuator, such as a linear motor. Preferably, the slidable arm is in the charging unit housing, although this is not essential. The actuator is controlled to slide the arm 74 by way of a controller 32, disposed in the charging unit 13 or disposed elsewhere in the system. An array of sensor coils 75 is disposed on the slidable arm 74. The arm 74 is rectangular and spans a width slightly less than the width of the sensing region 78. The sensing coils 75 are coupled to control electronics. The arm 74 is sized appropriately to carry the sensor coil array 75. The sensor coils 75 can be any suitable used in the art. The slidable arm 74 and/or sensor coils 75 can be shielded to reduce interference from the charging coil 77.

The following regions are also shown:
A charging pad 70 housing that is rectangular.
An operational region 71, being the region over which the wireless power transfer coil can transfer power. This typically would be of similar region to the charging pad 70. This may actually be quasi-oblong, or some other shape that is that reflects the total electromagnetic field of the power coils 77. Irrespective, the operational area 71 will most likely be of a similar magnitude of size and cover or extend beyond the rectangular pad area 70. That is, preferably the sensing region 78 coincides with the operational region 71. However, some useful gains could be obtained even if there is not full coincidence.
A slidable arm 74 with sensor coils 75 that covers an elongated rectangular region.
A sensor field 73, which is the region that the sensor coils 77 can sense an object 72 when the rotatable arm 74/sensor coil array 75 as in a particular position.
An approximately rectangular sensing region 78, being the region over which the sensing field 73 scans or sweeps through sliding movement of the arm 74.

The area covered by the sensor coil array 75 and the slidable arm 74 and the sensing field 73 is a small proportion of the overall operational area 71, which is advantageous for the reasons described above. In particular, the sensing field 73 and sensing region geometry 78 are arranged in relation to the operational region 71 so that there is at least one position of the sensing field such 73 that it does not overlap the foreign object 72 in the operational area 71 (see positions A and C), and at least one position of the sensing field 73 such that it does overlap the foreign object 72 in the operational area 71 (see position B). In practice, there will be many such positions of each. There is clearance between the slidable arm 74 and the charging unit pad 70 so that as the arm 74 moves it will pass above any foreign object 72 on the pad 70 or otherwise in the operational area 71.

In use, arm 74 is manipulated by an actuator that can move the bar across the sensing region, e.g. position A through position B to position C. The actuator can be any suitable mechanism such an electromagnetic rail, for example. The actuator is controlled by a controller 32 in the charging unit, in the controller unit 32, or elsewhere in the system.

The slidable bar 74 is moved laterally by the actuator under control of the controller 32 so that the sensor coil array 75 scans/sweeps across a rectangular movement region 79 and the sensing field 73 scans/sweeps out a quasi-rectangular sensing region 78, allowing the sensor coil array 55 to sense any foreign objects 72 located in the sensing region 78/operational region 71. Three positions of the slidable arm 74 are shown A, B,

C, although it will be appreciated that the arm 74 will move through a continuous range of different positions. As can be seen, as the arm 74 moves, for most of the positions, the sensing field 73 does not cover the foreign object 72, but for a small part of the scan (for a smaller range of positions) the arm 74 covers (and therefore the sensing field 73 covers) the foreign object 72.

The arm 74 moves transversely across from one end of the sensing region 78 to the opposite end, allowing the area and sensing field 73 scan a sensing region 78 to sense for any foreign objects 72 located in the operational region 71. The sensor coil array 75 will not sense the object 72 when the arm 74/sensor coil array 75 is positioned so the sensor field 73 does not overlap (such as not cover or is too far away to sense) the foreign object 72. See for example positions A and C. The controller 32 receives output from the sensor coil array 75 that is essentially a null signal 80 (see FIG. 8) or a signal indicative of no object. Once the sensor coil array 75 is in one of the positions such that the sensing field 73 overlaps (such as covers or is near enough to sense) the foreign object 72(e.g. position B), the controller 32 receives output from the sensor coil array 75 that is a positive signal 81 from which the controller 32 detects the foreign object 72. The controller 32 can use the relative outputs from when the sensing field 73 does not sense or overlap the object 72 to when it does overlap/sense the object 72 to assist in distinguishing the two events.

For example, referring to FIGS. 7 and 8, at position A, the arm 74 is at the edge of the sensing region 78, and the foreign object 72 is too far from the arm 74 to induce an electrical signal into any of the sensing coils 75 located along the arm 74. As no electrical signal is induced in any of the sensing coils 75, the controller 32 receives a (“low”) zero reading 80 from the arm. The arm 74 begins to move further to the right towards position B. At position B, the sensing bar 74 is positioned in the middle portion of the sensing region 78. At this position, the sensing bar 74 overlaps with the foreign object 72, and the foreign object 72 is close enough to induce an electrical signal into at least one sensing coil 75 located along the arm 74. Since an electrical signal is induced in at least one of the sensing coils 75, the controller 32 receives a (“high”) 81 non-zero reading. The arm 74 continues to move further to the right towards position C. At position C, the arm 74 is at the edge of the sensing region 78, and similar to position A, the foreign object 72 is too far from the arm 74/sensing field 73 and the controller 32 therefore receives a (“low”) 80 zero reading from the arm 74. From position C, the travelling direction of the sensing bar 74 can reverse, so that the sensing bar 74 starts to move back towards position A.

By moving the sensing bar 74 from position A to position C, the controller 32 receives a (“low”) 80 zero reading and a (“high”) 81 non-zero reading. The controller 32 is able reference the a (“high”) non-zero reading 81 against the (“low”) zero reading 80 to correctly determine that there is a foreign object 72 within the sensing region 78. The controller 32 then powers down the inductive coils 77 of the charging pad 70 to prevent induction heating of the foreign object 72. The foreign object 72 is then no longer an induction heating hazard.

Once the detection takes place the controller 32 can communicate with the system controller to take appropriate action, such as shutting down power transfer. Those skilled in the art would understand that as alternative to continuously moving the bar 74 in a continuous motion, the bar 74 can rotate in other ways. For example, the slidable bar 74 can move with an alternating “stop” and “start” movement.

The disclosed embodiment suggests sensing and detecting different voltage signals (i.e. a non-zero reading when a foreign object is present, and a zero reading when a foreign object is absent) to determine whether a foreign object 72 is present in the sensing region 73. Those skilled in the art would understand that the controller 32 can be configured to instead measure a different parameter to ascertain whether a foreign object 72 is present in the sensing region 73. That is, instead of using relative voltage levels, the controller can instead measure frequency, phase shift, or some other parameter, for example.

### 3. Variations

It will be appreciated that for the embodiments described above are there could be a number of variations. For example, there does not need to be a single array of coils for the sensor coil array—there could be two, three or even more array of coils, each array comprising one or more columns of coils. Furthermore, each array of coils may each be disposed on its own arm—that is, some embodiments may have multiple sensing arms, with each sensing arm having its own array of coils. Each sensing arm could move independently, or together. Furthermore, the number of coils can be any number suitable. The consideration for the number of coils will of course be the sensitivity, but also the compromise between that and optimising the smallest size of the sensor coil array (and therefore the arm) so that the cost can be kept to a desirable level, the shielding can be kept to a desirable level and also the array can always be put in a position where it does not detect a foreign object and another position where it does detect foreign object to enable the referencing between the two readings to improve detection.

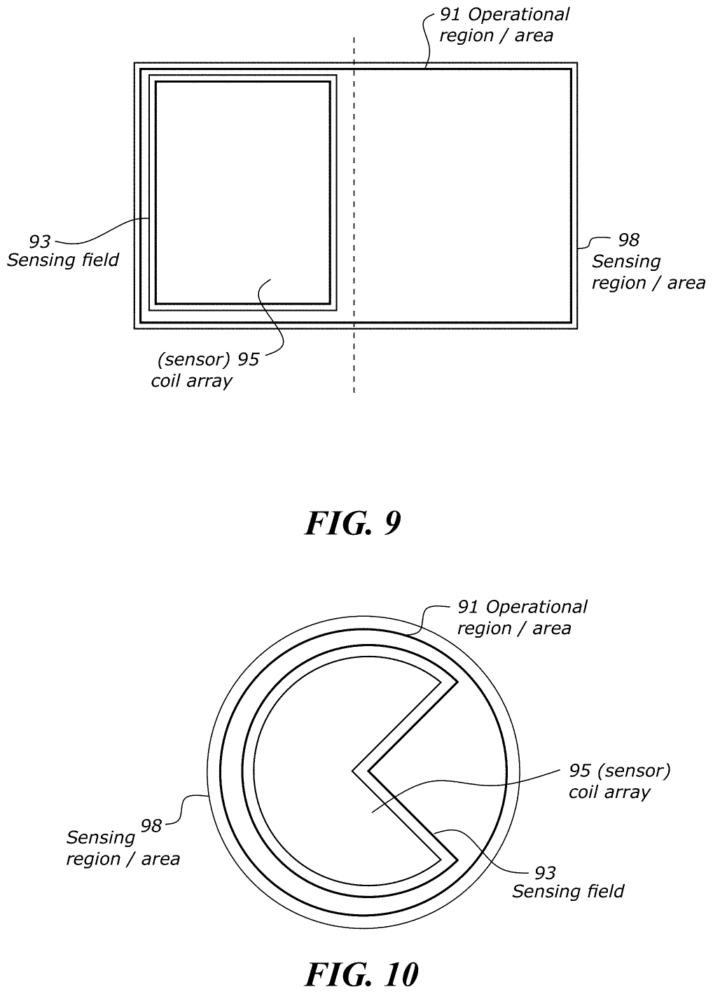

Referring to FIG. 9, in slidable arm 94 arrangements where the operational area 91 and sensing region 98 are rectangular, typically the largest size of the sensor coil array 95 will generate a sensing field 93 with an area slightly less than half the area of the sensing region 98, so that at least a non-sensing and a sensing position of a foreign object can exist. In practice, it would be desirable to have a sensor coil array 95 that generates a sensing field 93 much smaller than this. For example, the sensing field 93 area could be less than 50% of the area of the sensing region 98, or less than 40% of the area, or less than 30% of the area, or less than 25% of the area, or less than 10% of the area of the sensing region 98.

Referring to FIG. 10, in a rotating arm arrangement 104, where the operational area 101 and the sensing region are circular, the sensor coil array 104 could in theory be a significant proportion of a full circle, to produce a sensing field 103 that is a significant proportion of a full circle with a small area that the sensing field 103 does not occur. This means that when the rotation of the sensor coil array 105 occurs, there is still a small area of the sensing region 108 where no sensing occurs. However, in practice it would be more desirable to have a sensor coil array 105 that generates a sensing field 103 much smaller than this, more akin to what was described in the embodiment above.

The embodiments above relate to a charging unit. Wireless power transfer can also be used for real-time powering of systems and/or devices without or in addition to charging. The embodiments above could be used with such systems also.

### 4. Shielding

As discussed earlier, shielding is helpful for attenuating the electromagnetic flux emitted from the inductive coils 14, 57, 77, such that electromagnetic interference with the signals induced in the sensing coils of the sensing array 45, 55, 75 is mitigated. In comparison to the sensing arrays, the sensing bars 44, 54, 74 according to the disclosed embodiments can incorporate more shielding material, because the sensing bars 44, 54, 74 occupy a smaller area relative to the scanning region 48, 58, 78.

### 5. Advantages

The disclosed embodiments may have one or more of the following advantages:
The sensing bars 44, 54, 74 are small relative to the size of the sensing region 48, 58, 78 that they need to scan. The sensing bars 44, 54, 74 are moveable to scan the entire sensing region 48, 58, 78. The combination of the size of the bar 44, 54, 74 (relative to size of sensing region48, 58, 78), and the means of moving the sensing bar 44, 54, 74 ensures that the wireless charging pad 40, 50, 70 can detect the presence of a foreign object 42, 52, 72, irrespective of the size of the foreign object 42, 52, 72, where it is located within the sensing region 48, 58, 78, or whether the foreign object 42, 52, 72 is stationary.
The small area of the sensing bar 44, 54, 74 restricts the amount of coil material and/or restricts the number of sensing coils 45, 55, 75 that can be placed. Consequently, fewer supporting electronic components are required producing a simpler electronic circuitry to manufacture and repair. The cost to manufacture and maintain is therefore cheaper.
The sensing bars 44, 54, 74 can have more shielding than is possible with a sensing array that covers most of the sensing region 48, 58, 78 of a wireless charging pad 40, 50, 70. The extra shielding that the sensing bars 44, 54, 74 can have means the sensing coils 45, 55, 75 pick up less interference from the electromagnetic flux generated by the inductive coils 14, 57, 77, while still ensuring there is a sufficient rate of wireless power transfer from the wireless charging pad 40, 50, 70 to the electric vehicle 11. As the sensor coil arrays 45, 55, 75 require a smaller area of shielding, a greater level (e.g. thickness) of shielding around the sensor coil arrays 45, 55, 75 can be provided without impeding on the operation of the wireless power transfer coils 14, 57, 77. The extra shielding reduces electromagnetic interference from the wireless power transfer coils 14, 57, 77 which improves the quality of the signal sensed by the sensor coil arrays 45, 55, 75. This improves the accuracy and/or precision of the measurements of the sensor coil arrays 45, 55, 75. Further, the extra shielding thickness allows the controller 32 to be placed closer to the sensor coil arrays 45, 55, 75. Placing the controller 32 physically closer to the sensor coil arrays 45, 55, 75 also improves the accuracy and/or precision of the sensor coil arrays 45, 55, 75 measurements.

As illustrated in FIG. 11, 12, prior art arrangements normally comprise of an array of sensing coils (referred to as “sensing array” herein) located underneath the charging surface (referred to as “sensing region” herein) of the wireless charging pad. The array of sensing coils normally spans across the entirety (or at least a large portion) of the charging pad area. The large size of the sensing array relative to the size of the wireless charging pad is problematic for several reasons:
First, prior art arrangements that use sensor coils to sense foreign objects can only detect foreign objects if an induced measurement (“high” and/or “non-zero”) representing the presence of the foreign object can be referenced against a weaker or a substantially non-existent (“low” and/or “zero”) measurement that represents the absence of the foreign object. Prior to operation, the prior art is calibrated so that the system can distinguish between a “high” and a “low” measurement and/or distinguish between a “non-zero” and “zero” measurement. If a stationary foreign object sits on the pad during start up, the prior art arrangement would not be able to detect the foreign object. This is because the sensing array is too big, such that it will always sense the presence of the foreign object; and because a “low” and/or “zero” measurement will always be absent, the “high” and/or “non-zero” measurement is “misinterpreted” as an indeterminate measurement. In the example shown in FIGS. 9 and 10, the foreign object is located, such that a portion of the sensing array always “overlaps” with the foreign object,
Second, a wireless charging pad covers a relatively large surface area that needs to be scanned for foreign objects. The prior art arrangements would need a large number of sensing coils such that the entire charging pad can be scanned for foreign objects. This means a lot of coil material is required. Further, to detect small foreign objects, (which could be at least as small as a hair pin or a paper clip for example), the sensing coils need to be placed very close together to enable high-resolution sensing. Such placement of the sensing coils exacerbates the issue of requiring a lot of coil material needed to manufacture a wireless charging pad.
Third, the sensing array has shielding material to attenuate the electromagnetic flux emitted from the inductive coils, such that electromagnetic interference with the signals induced in the sensing coils of the sensing array is mitigated. The shielding material should still be magnetically “porous” enough such that the electromagnetic flux emitted from the inductive coils can still pass through such that there is still a sufficient wireless transfer of power. Referring back to the example of FIG. 11, the size of the sensing array is large relative to the top surface of the sensing array, which restricts the upper limit of how much shielding material can be applied to the sensing array. An excess amount of shielding would restrict the rate of wireless power transfer from the wireless charging pad to the electric vehicle.

1. A charging unit for wireless power transfer, comprising:
at least one coil for inductive power transfer,
a sensor coil array with a sensing field for sensing the presence of at least one foreign object, and
a controller configured to:
move the sensor coil array and/or sensing field so that the sensing field can scan a sensing region, and
detect the presence of the at least one foreign object in the sensing region based on the sensing array output,
herein the sensor coil array and/or sensing field is moveable such that the sensing field can be:
a) positioned in the sensing region so that the sensing field does not overlap the at least one foreign object, and also
b) positioned in the sensing region so that the sensing field does overlap the at least one foreign object.

2. A charging unit according to claim 1 wherein the charging unit is for wireles sly charging an electric vehicle through inductive power transfer.

3. A charging unit according to claim 1 further comprising an arm, wherein the sensor coil array is disposed on the arm, and the controller can control the move the arm to position the sensing field in the sensing region.

4. A charging unit according to claim 3 wherein the arm is a rotatable arm and the controller can rotate the arm to position the sensing field.

5. A charging unit according to claim 3 wherein the arm as a slidable arm and the controller can slide the arm to position the sensing field.

6. A charging unit according to claim 1 wherein the charging unit has an operational region and the sensing region overlaps the operational region.

7. A charging unit according to claim 6 wherein the sensor coil array and/or sensing field are smaller than the operational region.

8. A charging unit according to claim 1 further comprising one or more additional sensor arrays for sensing the presence the at least one foreign object

9. A charging unit according to claim 8 wherein each additional sensor array is disposed on a respective additional arm.

10. A charging unit according to claim 1 wherein the charging unit comprises electromagnetic shielding material for shielding the sensor coil array from electromagnetic interference.

11. A charging unit according to claim 1 wherein the charging unit is for wirelessly charging one or more of the following:
electrical system
battery
scooter
e-bike
robot
other electronic device

12. A charging unit for wirelessly charging an electric vehicle through inductive power transfer, comprising:
at least one coil for inductive power transfer,
a sensor coil array with a sensing field for sensing the presence of a foreign object, and
a controller configured to:
move the sensor coil array and/or sensing field so that the sensing field can scan a sensing region, and
detect the presence of a foreign object in the sensing region based on the sensing array output,
wherein the sensor coil array and/or sensing field is moveable such that the sensing field can be:
a) positioned in the sensing region so that the sensing field does not overlap the foreign object, and also
b) positioned in the sensing region so that the sensing field does overlap the foreign object.

13. A sensing unit for a charging unit for wireless power transfer comprising:
a sensor coil array with a sensing field for sensing the presence of at least one foreign object, and
a controller or in communication with a controller configured to:
move the sensor coil array and/or sensing field so that the sensing field can scan a sensing region, and
detect the presence of the at least one foreign object in the sensing region based on the sensing array output,
wherein the sensor coil array and/or sensing field is moveable such that the sensing field can be:
a) positioned in the sensing region so that the sensing field does not overlap the at least one foreign object, and also
positioned in the sensing region so that the sensing field does overlap the at least one foreign object.

14. A sensing unit according to claim 13 wherein the charging unit is for wireles sly charging an electric vehicle through inductive power transfer.

15. A sensing unit according to claim 13 further comprising one or more sensor arrays for sensing the presence the at least one foreign object.

16. A sensing unit according to claim 13 wherein the charging unit is for wirelessly charging one or more of the following:
electrical system
battery
scooter
e-bike
robot
other electronic device

17. A wireless power transfer system comprising a charging unit according to claim 12.

18. A power system for wireless power transfer for charging and/or real-time powering of a system or device, comprising:
at least one coil for inductive power transfer,
a sensor coil array with a sensing field for sensing the presence of at least one foreign object, and
a controller configured to:
move the sensor coil array and/or sensing field so that the sensing field can scan a sensing region, and
detect the presence of the at least one foreign object in the sensing region based on the sensing array output,
wherein the sensor coil array and/or sensing field is moveable such that the sensing field can be:
a) positioned in the sensing region so that the sensing field does not overlap the at least one foreign object, and also
b) positioned in the sensing region so that the sensing field does overlap the at least one foreign object.

19. A wireless power transfer system comprising a sensing unit according to claim 13.
